(19) United States
(12) Patent Application Publication
(10) Pub. No.: US 2002/0156768 A1
(43) Pub. Date: Oct. 24, 2002

(54) Repair parts ordering management system

(75) Inventor: Katsuya Ohta, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: HONDA GIKEN KOGYO KABUSHIKI KAISHA

(21) Appl. No.: 10/127,598

(22) Filed: Apr. 23, 2002

(30) Foreign Application Priority Data
Apr. 23, 2001 (JP) P.2001-124753

(51) Int. Cl. G06F 7/00

(52) U.S. Cl. 707/1

(57) ABSTRACT

A repair parts ordering management system that includes a parts account information database system. The parts account information database system may have a parts account information database storing at least one of parts numbers, classification information, and manufacturer information of repair parts. The parts account information database system is also operable to update and change the parts numbers, the classification information, and the manufacturer information. Also included in the repair parts ordering management system is an ordering account information database system that has an ordering account information database. The ordering account information database stores at least the parts numbers and the manufacturer information and can update and change this information. When at least one of the parts numbers, the classification information, and the manufacturer information in the parts account information database is changed, the parts account information database system is operable to output the changed information, whereby the ordering account information database is also updated or changed.

### BACKGROUND OF THE INVENTION

1. Field of the Invention

This invention relates to a repair parts ordering management system. More particularly, the invention relates to a repair parts ordering management system that makes it possible to efficiently conduct ordering management of repair parts of automobiles.

2. Description of the Related Art

In the related art, a system as shown in FIG. 5 has been used as a repair parts ordering management system. Such a repair parts ordering management system is used in a repair parts procurement department of an automobile manufacturing company. FIG. 5 is a combined drawing of a block diagram and a flowchart to describe the system.

In FIG. 5, item 1 denotes a parts account information database storing information concerning repair parts such as parts numbers, classification information, and manufacturer information of the repair parts.

The parts number is a unique number given to each repair part and can be a character string consisting of numeric and alphabetic characters.

The classification information is application information of the repair parts. For example, if the repair parts are used in current models, they are classified into “currently available parts;” if the repair parts are used only with old models, they are classified into “old model parts;” if the repair parts are integrated into other similar parts, they are classified into “integrated parts,” and so on. In fact, the classification information is assigned digits. For example, 1 is assigned to the “currently available parts,” 2 is assigned to the “old model parts,” and 4 is assigned to the “integrated parts,” and these digits are recorded in the database.

As an example, a case where a piston P1 of an engine of an automobile of model A1 is the repair part is discussed below.

If the piston P1 is used in a current automobile engine, the classification information of the repair part is “currently available parts” and “1” is assigned. If the piston P1 is used only with old model A0 of the automobile A1, the classification information of the repair part is “old model parts” and “2” is assigned. If the piston P1 is integrated into a piston P2 of an engine of an automobile B1, being another similar part, the classification information of the repair part is “integrated parts” and “4” is assigned.

Various types of classification information other than described above are available. For example, if the repair parts are parts of an overseas dedicated model and thus are not applied domestically, they are classified into “unapplied” and “5” is assigned; if production of the corresponding model is stopped and sale of parts is also stopped, they are classified into “sale stop” and “6” is assigned, and so on.

The manufacturer information is the name of the manufacturer from which the repair parts are ordered, the code number assigned to the manufacturer, or the like.

The described parts account information database 1 is constructed on a hard disk of a personal computer (not shown), for example, and a parts account information database system is provided by the personal computer. As known, the personal computer comprises at least a CPU, a hard disk, an operation section such as a keyboard, a display, required software, and the like.

Also, the computer allows for changing the classification information and the manufacturer information concerning the repair parts.

As for the classification information, for example, if the repair parts used only with old models become used also with a new model, the classification information of the repair parts must be changed from “2” (old model parts) to “1” (currently available parts). If the repair parts classified into “unapplied” domestically because of overseas dedicated model parts become used with a new domestic model, the classification information of the repair parts must be changed from “5” (unapplied) to “1” (currently available parts) Further, if the repair parts whose sale is also stopped because production of the corresponding model is stopped are integrated into other similar repair parts and consequently are again sold, the classification information of the repair parts must be changed from “6” (sale stop) to “4” (integrated parts).

If the classification information is thus changed, the parts need to be distinguished according to the classification information, although they have the same parts name and thus the parts are given different numbers as the parts numbers. In such a case, the total number of parts identified by the parts numbers may reach several million for an automobile.

As for the manufacturer information, for example, to change the parts manufacturer of the order-receiving party fitted in response to an increase or decrease in the production amount of the parts as the classification information is changed as described above, to change to a B factory for producing the repair parts of a new model because the new model is produced in the B factory although the old model is produced in an A factory and thus the repair parts are also produced therein, or to change to an overseas order-receiving party as the repair parts manufacturer or factory is relocated overseas, it becomes necessary to change the manufacturer information.

Therefore, the described parts account information database system is designed so as to make it possible to change the classification information and the manufacturer information using the computer.

In FIG. 5, numeral 2 denotes an ordering account information database. As the information concerning repair parts, at least the parts numbers of the repair parts and the manufacturer information for each repair part a restored. The parts numbers and the manufacturer information are as described above.

The ordering account information database 2 is also constructed on hard disk of a personal computer (not shown), for example, and an ordering account information database system is provided by the personal computer.

At least the manufacturer information of the party from which each part is ordered can be changed in a similar manner to that described above.

The repair parts ordering management system shown in FIG. 5 has a parts number information database 3, a prediction management database 4, and a back order (B/O) database 5 in addition to the parts account information database 1 and the ordering account information database 2.

The repair parts names and the parts numbers of the repair parts (unique numbers to the repair parts) are stored in the parts number information database 3 in relation to each other.

To determine the ordering time and the order amount of repair parts to keep a proper number of the repair parts in stock at all times, the prediction management database 4 is referenced; the database 4 stores the parts names and the parts numbers of the repair parts, the end-use demand results of the repair parts (sales performance for customers), the received order results for the repair parts from repair shops, etc., the sales performance of finished products (in this case, automobiles) using the parts, and the like in relation to each other.

If already ordered and undelivered parts exist, the back order database 5 is provided for storing and processing the number of undelivered parts (the back order (B/O) number), and the parts name of the parts, the parts number, the manufacturer information, the number of already ordered parts, the back order number, and the like.

A repair parts ordering management job using the described repair parts ordering management system will be discussed with reference to FIG. 5. The items (1) to (6) in FIG. 5 correspond to the items (1) to (6) in the following description:

(1) The user of the system enters the end-use demand results of the repair parts (sales performance for customers), the received order results for the repair parts from repair shops, the sales performance of finished products using the parts (in this case, automobiles), and the like in the prediction management database 4.

(2) Upon reception of a design change notification from a manufacturing plant (in this case, an automobile manufacturing plant), the user adds, changes, etc., the corresponding parts data in the parts number information database 3. If a survey on the design change notification is required, the user carries out a survey, and then adds, changes, etc., the corresponding parts data in the parts account information database 1.

(3) The user checks the information in the prediction management database 4 at evenly spaced periods of time, such as daily, and predicts the ordering time and the order amount of repair parts assumed to be required to keep a proper number of the repair parts in stock based on the information.

(4) When the predicted ordering time comes, the user orders the repair parts from the manufacturer of the order-receiving party for the repair parts recorded in the ordering account information database 2.

(5) Then, when the repair parts are delivered to the distribution center, etc., for example, the user checks whether or not the repair parts are proper and whether or not the quantity is sufficient. If the quantity is not sufficient, the user records the insufficient number of material parts (the back order number and if defective pieces are contained, the number of the defective pieces) in the back order database 5. The record contents can be checked on a display of the personal computer providing the system of the back order database 5.

(6) Upon reception of an order for repair parts from an automobile distributor, repair shop, etc., the order is entered in the prediction management database 4 as the received order results in (1) and the repair parts are taken out of storage and are shipped. The repair parts for which an order is given from abroad may be loaded into a ship for transport.

As described above, to perform the ordering job (4), the ordering account information database 2 is referenced and an order is given to the manufacturer of the order-receiving party for the repair parts recorded in the ordering account information database 2. However, since the parts account information database 1 and the ordering account information database 2 are not reliably associated with each other in the current repair parts ordering management system, a situation often occurs in which although the manufacturer information (order-receiving party) is changed in the parts account information database 1, the change is not reflected in the ordering account information database 2.

Thus, an order is given to a manufacturer to which the order should not be given (resulting in an order omission) and since repair parts are not delivered from the manufacturer to which the order should have been given, an increase in the back order number of repair parts occurs.

To identify the cause of such trouble, the information contents in the parts account information database 1 and the parts number information database 3 must be checked one by one (see the alternate long and short dashed lines in FIG. 5) and then the order must again be given to the manufacturer to which the order should have originally been given and consequently, the smooth ordering management work of the repair parts is hindered.

### SUMMARY OF THE INVENTION

It is therefore an object of the invention to provide a repair parts ordering management system that can solve the above-identified problems, enables a smooth ordering management job to be conducted, and also lowers the number of back order number repair parts.

To the end, according to a first aspect of the invention, there is provided a repair parts ordering management system comprising:

a parts account information database system including a parts account information database storing at least one of parts numbers, classification information, and manufacturer information of repair parts, wherein the parts account information database system is operable to update and change the parts numbers, the classification information, and the manufacturer information; and

an ordering account information database system including an ordering account information database storing at least the parts numbers and the manufacturer information, wherein the ordering account information database system is operable to update and change at least the manufacturer information,

wherein when at least one of the parts numbers, the classification information, and the manufacturer information in the parts account information database is changed, the parts account information database system is operable to output the changed information,

whereby the ordering account information database is updated or changed based on the output of the changed information.

According to a second aspect of the invention, there is provided a repair parts ordering management system comprising:

a parts account information database system including a parts account information database storing at least one of parts numbers, classification information, and manufacturer information of repair parts, wherein the parts account information database system is operable to update and change the parts numbers, the classification information, and the manufacturer information; and

an ordering account information database system including an ordering account information database storing at least the parts numbers and the manufacturer information, wherein the ordering account information database system is operable to update and change at least the manufacturer information,

the ordering account information database also operable to communicate and exchange information with the parts account information database system such that when the manufacturer information in the parts account information database is updated or changed, the manufacturer information is also updated or changed in the ordering account information database.

Further, the repair parts ordering management system as claimed in the first or second aspect can additionally comprise:

a back order database system including a back order database operable to store backorder information regarding undelivered repair parts, the back order database system operable to communicate and exchange information with the ordering account information database system,

wherein when the ordering account information database system is updated or changed, the back order information is updated or changed accordingly.

Thus, the repair parts ordering management system as claimed in the first aspect can provide the following advantages:

After the classification information or the manufacturer information in the parts account information database in the parts account information database system is changed, the changed information can be listed, so that it is made possible for the user to change the manufacturer information corresponding to the parts in the ordering account information database based on the list.

Thus, it is made possible for the user to very efficiently change the manufacturer information corresponding to the parts in the ordering account information database.

For example, if the number of repair parts reaches several million as described above, it is made possible to very efficiently change the manufacturer information corresponding to the parts in the ordering account information database based on the list.

Therefore, if the manufacturer information (order-receiving party) is changed in the parts account information database, the information in the ordering account information database can also be changed promptly without omission and consequently, a situation in which an order is given to a manufacturer to which the order should not be given (resulting in an order omission) is prevented from occurring and the number of undelivered parts is also remarkably decreased.

Therefore, it also becomes unnecessary for the user to check the information contents in the parts account information database one by one and it is made possible to conduct a smooth ordering management job of repair parts.

As described above, the repair parts ordering management system can provide the advantages that the ordering management job can be conducted smoothly and that the number of undelivered parts is also decreased.

The repair parts ordering management system in the second aspect of the invention provides the following advantages:

The ordering account information database is associated with the parts account information database system and when the manufacturer information in the parts account information database is changed, the manufacturer information corresponding to the parts in the ordering account information database is also changed. Thus, if the user changes the manufacturer information (order-receiving party) in the parts account information database, the corresponding information in the ordering account information database is automatically changed.

Therefore, a situation in which an order is given to a manufacturer to which the order should not be given (resulting in an order omission) is prevented from occurring and the number of undelivered parts is also reliably and remarkably decreased.

Accordingly, it also becomes unnecessary for the user to check the information contents in the parts account information database one by one and it is made possible to conduct a smoother ordering management job of repair parts.

As described above, the repair parts ordering management system can provide the advantages that the ordering management job can be conducted more smoothly and that the number of undelivered parts is also reliably decreased.

According to the repair parts ordering management system in the third aspect of the invention, in the repair parts ordering management system in either of the first two aspects, a back order database storing the number of the undelivered parts is connected to the ordering account information database system and after the manufacturer information is changed, at least when the parts are newly ordered, the number of the undelivered parts is displayed. Thus, after the manufacturer information is changed, it is still made possible to reliably keep track of the number of undelivered parts.

### BRIEF DESCRIPTION OF THE DRAWINGS

FIG. 1 is a schematic diagram showing a first embodiment of a repair parts ordering management system according to the invention and is a combined diagram of a block diagram and a flowchart;

FIGS. 2A to 2C are data display screens provided by a parts account information database system; FIG. 2A shows data before change, FIG. 2B shows data after change, and FIG. 2C shows a list of changed information;

FIG. 3 is a diagram showing an example of a display screen provided by a back order database system;

FIG. 4 is a schematic diagram showing a second embodiment of a repair parts ordering management system according to the invention and is a combined diagram of a block diagram and a flowchart; and

FIG. 5 is a schematic diagram showing a repair parts ordering management system in the related art and is a combined diagram of a block diagram and a flowchart.

### DETAILED DESCRIPTION OF THE PREFERRED EMBODIMENTS

Referring now to the accompanying drawings, description will be given of preferred embodiments of the invention.

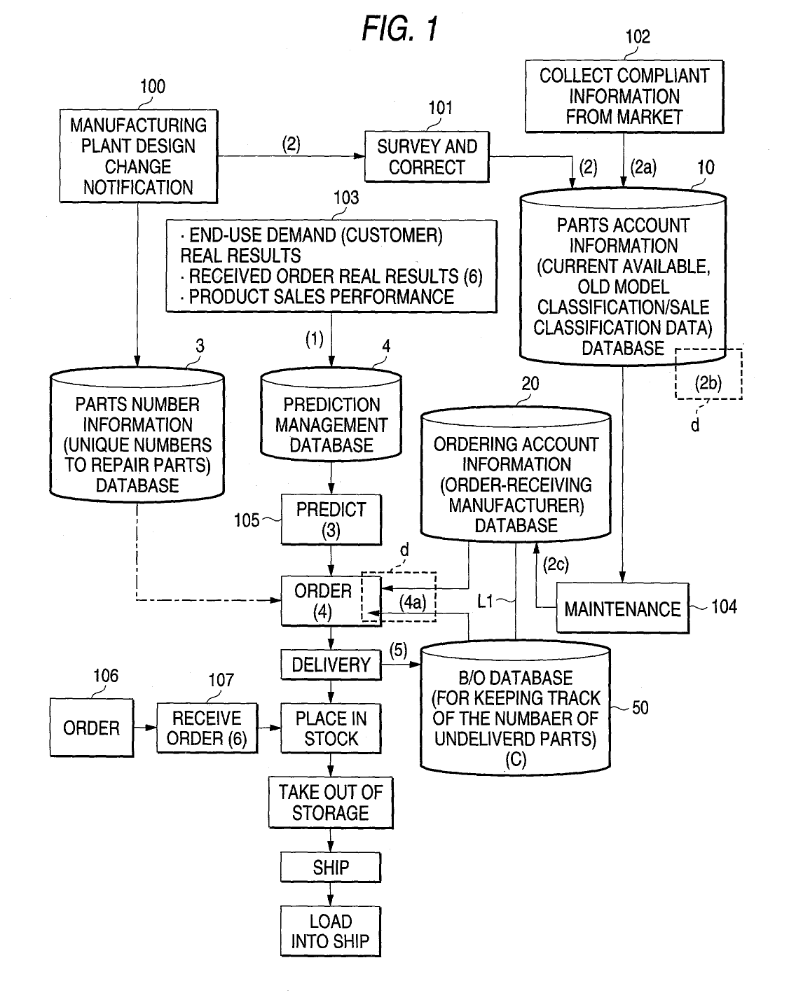

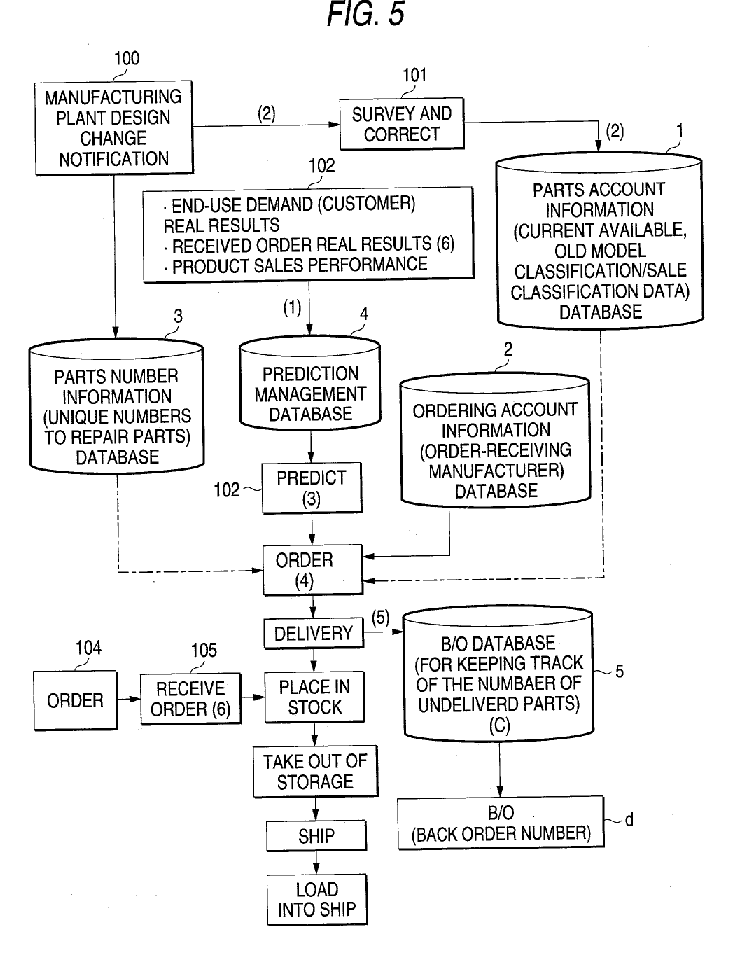

FIG. 1 is a schematic diagram to show a first embodiment of a repair parts ordering management system according to the invention and is a combined diagram of a block diagram and a flowchart. Parts identical with those of the system previously described with reference to FIG. 5 are denoted by the same reference numerals in FIG. 1.

In FIG. 1, item 10 denotes a parts account information database storing as the information concerning repair parts, at least the parts numbers, classification information, and manufacturer information of the repair parts.

The parts number is a unique number given to each repair part (for example, it may be a character string consisting of numeric and alphabetic characters, etc.), as described above.

The classification information is also as described above. In the embodiment, however, “integrated parts” are further classified into “integrated parts (incompatible)” and “integrated parts (compatible)” for the following reason:

The integrated parts should essentially be compatible and are considered to be compatible in the manufacturing plant (at the design stage), but it may be later determined that actually the integrated parts are incompatible from information, such as for example, complaints from the market including users, distributors, repair shops, etc. In such a case, the classification information of the repair parts must be changed from compatible to incompatible.

As an example, consider the above-described piston P1. In response to a design change notification from the manufacturing plant, the piston P1 is integrated into the piston P2 of the engine of the automobile B1 being another similar part, and thus the classification information is “integrated parts (compatible)”. However, if it is later determined that actually the integrated parts are incompatible according to information from the market, the classification information must accordingly be changed to “incompatible”.

Then, in the embodiment, the “integrated parts” are further classified into “integrated parts (incompatible)” and “integrated parts (compatible)” and “3” and “4” are assigned to the “integrated parts (incompatible)” and the “integrated parts (compatible)”, respectively.

As the manufacturer information, the name of the manufacturer from which the repair parts are ordered (manufacturer name) and the code number assigned to the manufacturer are stored.

The parts account information database 10 is constructed on a hard disk of a personal computer (not shown), for example, and a parts account information database system is provided by the personal computer.

The parts account information database system is designed so as to make it possible for a user using the computer to change the classification information and the manufacturer information similar to the system shown in FIG. 5.

Further, in the embodiment, when the classification information or the manufacturer information is changed, the changed information can be output, such as displayed on a computer display screen, printed, transmitted to other computers or devices, stored for later retrieval, etc.

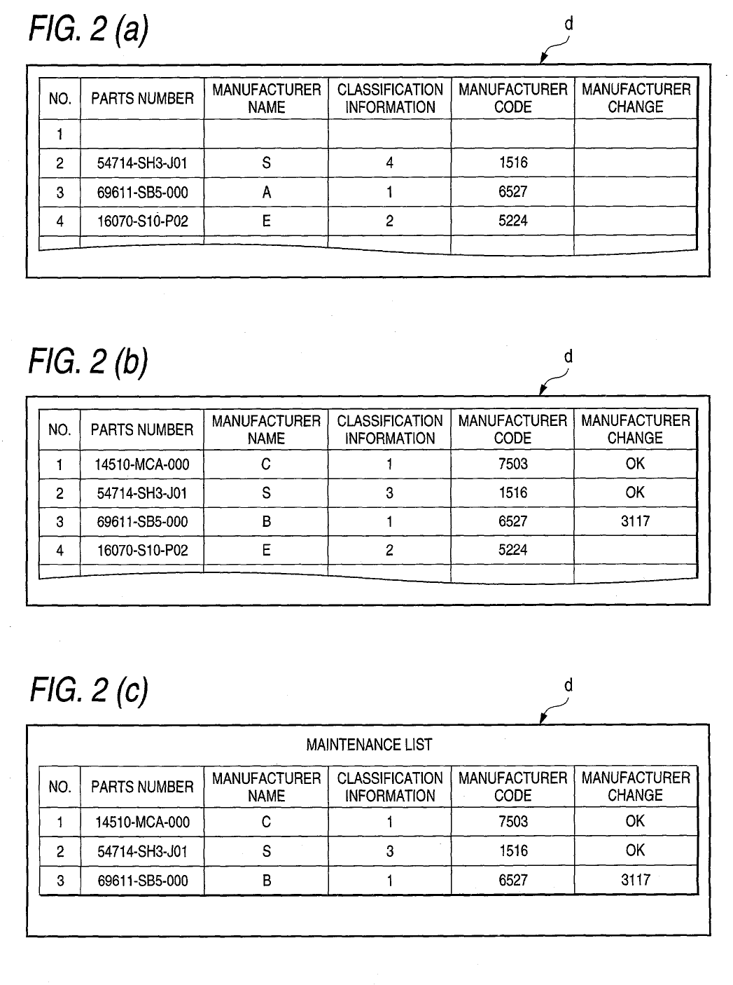

This point will be specifically discussed with reference to FIG. 2.

FIGS. 2A to 2C are data display screens provided by the parts account information database system; FIG. 2A shows data before change, FIG. 2B shows data after change, and FIG. 2C shows a list of changed information.

Taking the data No. 2 as an example, the meaning of the data shown in FIG. 2A being the data before change, is that the part number of the corresponding repair parts is “54714-SH3-J01”, that the manufacturer (order-receiving party) name is “S”, that the classification information is integrated parts (compatible) “4”, and that the manufacturer code is 1516.

The meaning of the data shown in FIG. 2B, the data after change, is as follows:

The data No. 1 is data of newly added repair parts (parts number 14510-MCA-000), meaning that the manufacturer name is “C”, that the classification information is currently available parts “1”, that the manufacturer code is 7503, and that the manufacturer change is OK because a manufacturer change is not required.

As for the data No. 2, it is determined from complaints from the market (see (2a) in FIG. 1) that the repair parts (parts number “54714-SH3-J01”) are incompatible and thus the classification information is changed from integrated parts (compatible) “4” (see FIG. 2A) to integrated parts (incompatible) “3”. However, the manufacturer name and the manufacturer code may be unchanged and thus the manufacturer change column is OK.

As for the data No. 3, the party or manufacturer from which the repair parts (parts number 69611-SB5-000) are ordered must be changed because of an increase or decrease in the production quantity or the like and thus the manufacturer name is changed from “A” (see FIG. 2A) to “B” and therefore the manufacturer code is also changed from “6527” to “3117” under the manufacturer change column.

The data No. 4 is not changed.

In FIGS. 2A and 2B, only the data Nos. 1 to 4 are displayed; in fact, the number of repair parts may reach several million and thus, several million data numbers may also exist.

In the parts account information database system, when the changes are inputted as described above, for example, and then a change list is displayed by operating the operation section of the computer, such as the keyboard, etc., as shown in FIG. 2C, the data of only the changed data (in this case, Nos. 1 to 3) is displayed and the list can be output (for example, printed out) as required.

In FIG. 1, numeral 20 denotes an ordering account information database. As the information concerning repair parts, at least the parts numbers of the repair parts and the manufacturer information for each repair part are stored as in the ordering account information database 2 shown in FIG. 5. The ordering account information database 20 is also constructed on a hard disk of a personal computer (not shown), for example, and an ordering account information database system is provided by the personal computer.

At least the manufacturer information of the party from which each part is ordered can be changed in a similar manner to that described above.

If already ordered and undelivered parts exist, like the back order database 5 shown in FIG. 5, the back order database 50 is provided. The number of undelivered parts, the parts name of the parts, the parts number, the manufacturer information, the number of already ordered parts, the back order number, and the like are stored in the back order database 50.

Further, the back order database 50 in the embodiment is associated with the ordering account information database 20 as indicated by L1 in FIG. 1 and when the information in the ordering account information database 20 is changed, the corresponding information in the back order database 50 is changed.

After the manufacturer information is changed, at least when the parts are newly ordered, the number of undelivered parts is displayed.

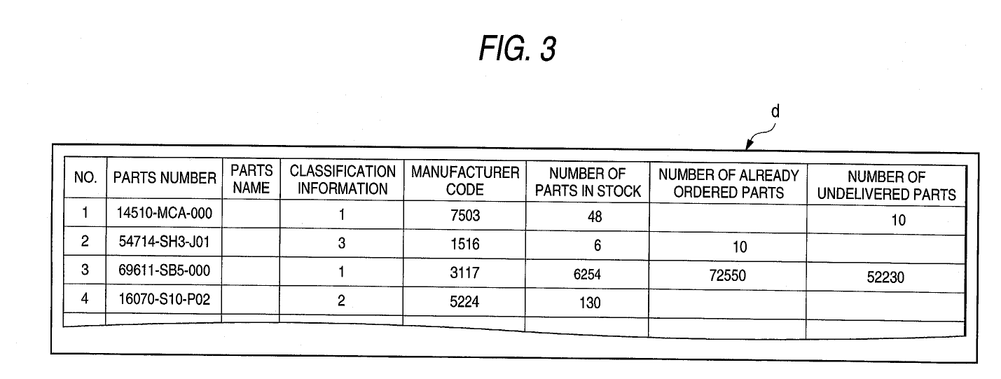

FIG. 3 depicts an example of a display screen displaying the number of undelivered parts. In the figure, data concerning the manufacturer (manufacturer code 6527) before changed to the manufacturer code 3117 is not displayed because the number of undelivered parts from the manufacturer (manufacturer code 6527) before changed to the manufacturer code 3117 is 0; if not 0, the number of undelivered parts from the manufacturer before changed to the manufacturer code 3117 is also displayed.

A repair parts ordering management job using the described repair parts ordering management system will be discussed with reference to FIG. 1. The digits (1) to (6) in FIG. 1 correspond to the digits (1) to (6) in the following description, and in the parts indicated by the same digits as those shown in FIG. 5, the same job contents are conducted, but the whole job flow will be discussed to ensure clear understanding.

(1) The user of the system enters the end-use demand results of the repair parts (sales performance for customers), the received order results for the repair parts, the sales performance of finished products using the parts (in this case, automobiles), and the like in a prediction management database 4.

(2) Upon reception of a design change notification from a manufacturing plant (in this case, an automobile manufacturing plant), the user adds, changes, etc., the corresponding parts data in a parts number information database 3. If a survey on the design change notification is required, the user carries out a survey, and then adds, changes, etc., the corresponding parts data in the parts account information database 10 (see (2b) in FIG. 1 and FIGS. 2A and 2B).

(2a) Further, the user collects complaint information, etc., from the market and changes, etc., the data of the corresponding parts in the parts account information database 10 based on the collected information.

For example, like the data No. 2 as described above, if it is determined from complaints from the market that the repair parts (parts number “54714-SH3-J01”) are incompatible, the classification information is changed from integrated parts (compatible) “4” to integrated parts (incompatible) “3” (see (2b) in FIG. 1 and FIGS. 2A and 2B).

(2c) After making the change above in (2) and (2a), further, as shown in FIG. 2B or 2C, the user lists the changed data or outputs (for example, prints out) the list as required, and also changes likewise the data in the ordering account information database 20 based on the list.

When the data in the ordering account information database 20 is changed, the corresponding data in the back order database 50 is also changed likewise.

(3) The user checks the information in the prediction management database 4 at evenly spaced periods of time, such as daily, and predicts the ordering time and the order amount of repair parts assumed to be required to keep a proper number of the repair parts in stock based on the information.

(4) When the predicted ordering time comes, the user orders the repair parts from the manufacturer of the order-receiving party for the repair parts, recorded in the ordering account information database 20.

(4a) At ordering, the data in the back order database 50 is displayed on a display d.

(5) Then, when the repair parts are delivered to the distribution center, etc., for example, the user checks whether or not the repair parts are proper and whether or not the quantity is sufficient. If the quantity is not sufficient, the user records the insufficient number of material parts (the back order number and if defective pieces are contained, the number of the defective pieces) in the back order database 50. The record contents can be checked on the display of the personal computer providing the system of the back order database 50.

(6) Upon reception of an order for repair parts from an automobile distributor, repair shop, etc., the order is entered in the prediction management database 4 as the received order results in (1) and the repair parts are taken out of storage and are shipped. The repair parts for which an order is given from abroad may be loaded into a ship for transport.

The repair parts ordering management system described above can provide the following advantages:

After the classification information or the manufacturer information in the parts account information database 10 of the parts account information database system is changed, the changed information can be listed (see FIG. 2C), so that it is made possible for the user to change the manufacturer information corresponding to the parts in the ordering account information database 20 based on the list.

Thus, it is made possible for the user to very efficiently change the manufacturer information corresponding to the parts in the ordering account information database 20.

For example, if the number of repair parts reaches several million as described above, only the changed data is listed and thus, it is made possible to very efficiently change the manufacturer information corresponding to the parts in the ordering account information database 20 based on the list.

Therefore, if the manufacturer information (order-receiving party) is changed in the parts account information database 10, the information in the ordering account information database 20 can also be changed promptly without omission and consequently, a situation in which an order is given to the manufacturer to which the order should not be given (resulting in an order omission) is prevented from occurring and the back order number is also remarkably decreased.

Therefore, it also becomes unnecessary for the user to check the information contents in the parts account information database 10 one by one and it is made possible to conduct a smooth ordering management job of repair parts.

As described above, the repair parts ordering management system can provide the advantages that the ordering management job can be conducted smoothly and that the back order number is also decreased.

The back order database 50 stores the number of the undelivered parts and may be connected to the ordering account information database system. After the manufacturer information is changed, at least when the parts are newly ordered, the number of the undelivered parts maybe displayed. Thus, after the manufacturer information is changed, it is still made possible to reliably keep track of the number of undelivered parts.

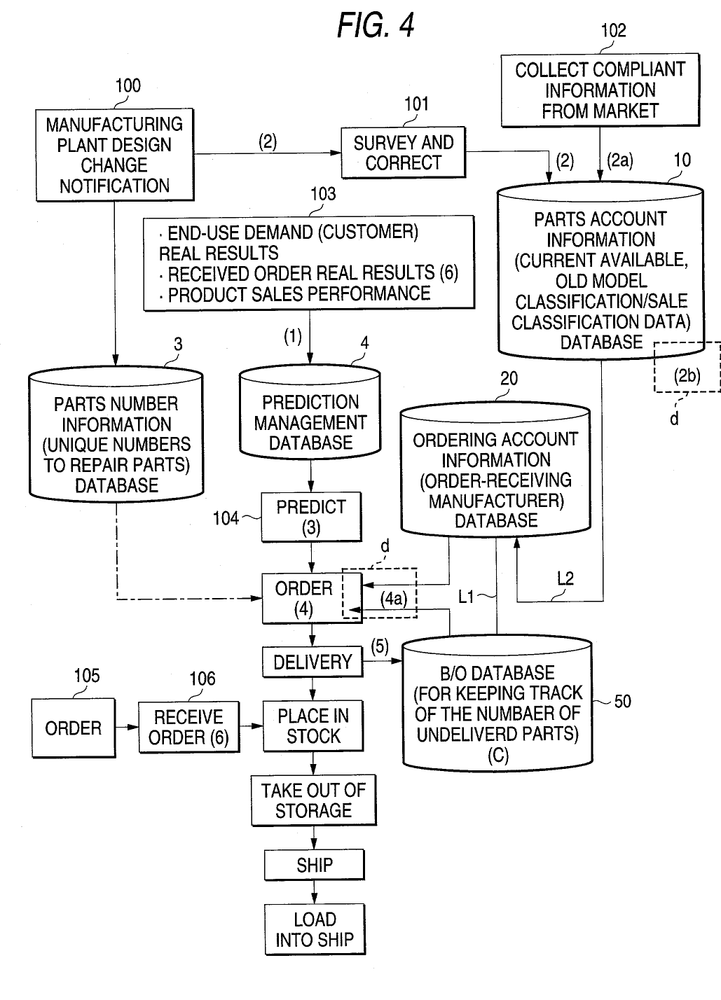

FIG. 4 is a schematic diagram showing a second embodiment of a repair parts ordering management system according to the invention and is a combined diagram of a block diagram and a flowchart. Parts identical with those of the first embodiment previously described with reference to FIG. 1 are denoted by the same reference numerals in FIG. 4.

The repair parts ordering management system of the second embodiment differs from that of the first embodiment only in that an ordering account information database 20 is associated with a parts account information database 10 (parts account information database system) (see L2 in FIG. 4) and when manufacturer information in the parts account information database 10 is changed, the manufacturer information corresponding to the parts in the ordering account information database 20 is also changed.

According to the second embodiment, if the user changes the manufacturer information (order-receiving party) in the parts account information database 10, automatically the corresponding information in the ordering account information database 20 is also changed, so that a situation in which an order is given to a manufacturer to which the order should not be given (resulting in an order omission) can be reliably prevented from occurring and the number of undelivered parts is also reliably and remarkably decreased.

Therefore, it is made possible to conduct a smoother ordering management job of the repair parts.

Although the invention has been described in its preferred embodiments, it is understood that the invention is not limited to the specific embodiments thereof and widely different embodiments of the invention may be made without departing from the spirit and scope thereof.

What is claimed is:

1. A repair parts ordering management system comprising:
a parts account information database system including a parts account information database storing at least one of parts numbers, classification information, and manufacturer information of repair parts, wherein the parts account information database system is operable to update and change the parts numbers, the classification information, and the manufacturer information; and
an ordering account information database system including an ordering account information database storing at least the parts numbers and the manufacturer information, wherein the ordering account information database system is operable to update and change at least the manufacturer information,
wherein when at least one of the parts numbers, the classification information, and the manufacturer information in the parts account information database is changed, the parts account information database system is operable to output the changed information,
whereby the ordering account information database is updated or changed based on the output of the changed information.

2. The repair parts ordering management system as claimed in claim 1, further comprising:
a back order database system including a back order database operable to store backorder information regarding undelivered repair parts, the back order database system operable to communicate and exchange information with the ordering account information database system,
wherein when the ordering account information database system is updated or changed, the back order information is updated or changed accordingly.

3. A repair parts ordering management system comprising:
a parts account information database system including a parts account information database storing at least one of parts numbers, classification information, and manufacturer information of repair parts, wherein the parts account information database system is operable to update and change the parts numbers, the classification information, and the manufacturer information; and
an ordering account information database system including an ordering account information database storing at least the parts numbers and the manufacturer information, wherein the ordering account information database system is operable to update and change at least the manufacturer information,
the ordering account information database also operable to communicate and exchange information with the parts account information database system such that when the manufacturer information in the parts account information database is updated or changed, the manufacturer information is also updated or changed in the ordering account information database.

4. The repair parts ordering management system as claimed in claim 3, further comprising:
a back order database system including a back order database operable to store backorder information regarding undelivered repair parts, the back order database operable to communicate and exchange information with the ordering account information database system,
wherein when the ordering account information database system is updated or changed, the back order information is updated or changed accordingly.

5. A method for repair parts ordering management comprising:
entering and storing repair parts information into a parts account information database and an ordering account information database, the repair parts information including at least one of parts numbers, classification information, and manufacturer information of repair parts;
updating or changing the repair parts information in the parts account information database based on received information;
outputting the updated or changed repair parts information;
updating the ordering account information database based on the outputted information.

6. The method for repair parts ordering management as claimed in claim 5, further comprising:
entering and storing the repair parts information into a back order database;
updating or changing the backorder database to include information on undelivered repair parts as well as updating or changing the repair parts information based on the outputted information,
outputting the number of the undelivered repair parts from the back order database at predetermined times.
